(19) United States
(12) Patent Application Publication
(10) Pub. No.: US 2002/0106607 A1
(43) Pub. Date: Aug. 8, 2002

(54) Dental flossing device

(76) Inventor: Amir Horowitz, Tel Aviv (IL)

Correspondence Address: BROWDY AND NEIMARK, P.L.L.C., 624 NINTH STREET, NW, SUITE 300, WASHINGTON, DC, 20001-5303, US

(21) Appl. No.: 09/777,717

(22) Filed: Feb. 7, 2001

(51) Int. Cl. A61C 15/00; A61C 1/07

(52) U.S. Cl. 433/118; 132/323; 132/326

(57) ABSTRACT

A flossing device having two times. An advancing mechanism advances an end of a piece of floss from the end of one tine to the end of the other tine so that a segment of the floss spans the inter-tine space. In use, an inter-dental space is placed in the inter-tine space and a segment of floss is advanced from one tine through the inter-dental space to the second tine. The end of the floss segment is locked to the second tine; and the floss is vibrated so as to floss the inter-dental space.

### FIELD OF THE INVENTION

The present invention relates generally to tooth flossing and, more particularly, to flossing devices.

### BACKGROUND OF THE INVENTION

Flossing is an effective method for cleaning between teeth to remove plaque buildup which is the primary cause of gingivitis, periodontitis, and tooth decay. A piece of floss is worked up and down against the tooth surfaces in the interdental spaces between the teeth. The floss may be held at the ends by the hands, or mounted into a hand held holder.

In order for the floss to be received between the teeth, it is generally necessary for the floss to be forced between the teeth from above. However, contact areas between adjacent teeth may make insertion of the floss difficult, if not impossible. Moreover, flossing, either by hand or with a holder cannot be used by persons wearing braces or who have bridgework because the floss cannot pass in the interdental space to the gums. Thus, U.S. Pat. No. 5,392,794 to Striebel discloses a dental floss threadable between adjacent teeth. A short piece of dental floss is bonded to a curved handle, and the floss is threaded between the teeth. U.S. Pat. No. 5,890,500 discloses a thin rigid guide tube through which a length of floss is threaded. The floss and guide are threaded between the teeth. The guide tube is then removed leaving the floss between the teeth for flossing.

### SUMMARY OF THE INVENTION

The present invention provides a mechanically activated flossing device. The device includes a pair of tines that in use are positioned so that they straddle an interdental space. Dental floss is fed from one tine through interdental space to the second tine. The end of the floss is reversibly grasped by a locking mechanism in the second tine. A vibrational motion of the tines generate a flossing action of the floss in the interdental space. When flossing of the interdental space is completed the floss is removed from the interdental space into one of the tines. The device is then positioned so that a new interdental space between two teeth to be flossed is located in the inter-tine space. This process is repeated until all interdental spaces have been flossed.

Thus, in its first aspect, the invention provides a flossing device comprising:

(a) a first tine and a second tine, each tine having a distal end, the distal ends being separated by an inter-dine space; and

(b) an advancing mechanism capable of advancing an end of a piece of floss from the distal end of the first tine to the distal end of the second tine so that at least a segment of the floss spans the inter-tine space.

In its second aspect, the invention provides a method of flossing an inter-dental space between two teeth comprising the steps of:

(a) placing the inter-dental space in an intertine of a flossing device having a first tine and a second tine;

(b) advancing a segment of floss from the first tine through the inter-dental space to the second tine;

(c) locking an end of the floss to the second tine; and

(d) vibrating the segment of floss so as to floss the inter-dental space.

### BRIEF DESCRIPTION OF THE DRAWINGS

In order to understood the invention and to see how it may be carried out in practice, two embodiments will now be described, by way of non-limiting examples only, with reference to the accompanying drawings, in which:

FIG. 1 is a flossing device in accordance with one embodiment of the invention;

FIG. 2 shows an exploded view of the flossing device of FIG. 1,

FIG. 3 shows a cross section at view of the flossing device of FIG. 1;

FIG. 4 shows a flossing device in accordance with a second embodiment of the invention;

FIG. 5 shows the interior of the embodiment show in FIG. 4 is an assembled view (FIG. 5a) and in an exploded view (FIG. 5b);

FIG. 6 shows the tines of the embodiment of FIG. 4 before threading of dental floss through the intertine space;

FIG. 7 shows the tines of the embodiment of FIG. 4 after threading of the dental floss through the intertine space;

FIG. 8 shows activation of a flossing cycle with the embodiment of FIG. 4;

FIG. 9 shows threading of dental floss through the interdental space by the embodiment of FIG. 4; and

FIG. 10 shows a flow-chart diagram of a flossing cycle executed by the embodiment of FIG. 4.

### DETAILED DESCRIPTION OF SPECIFIC EMBODIMENTS

### First Embodiment

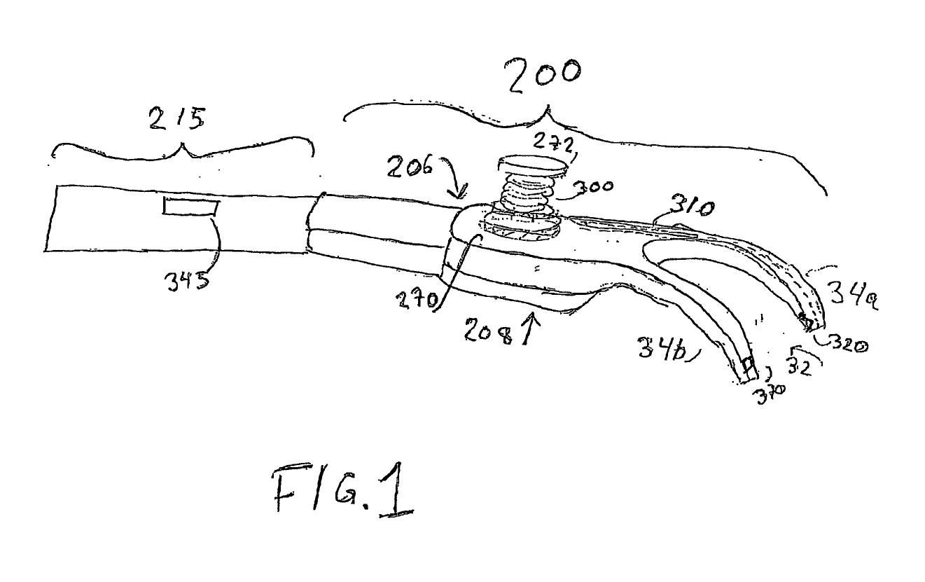

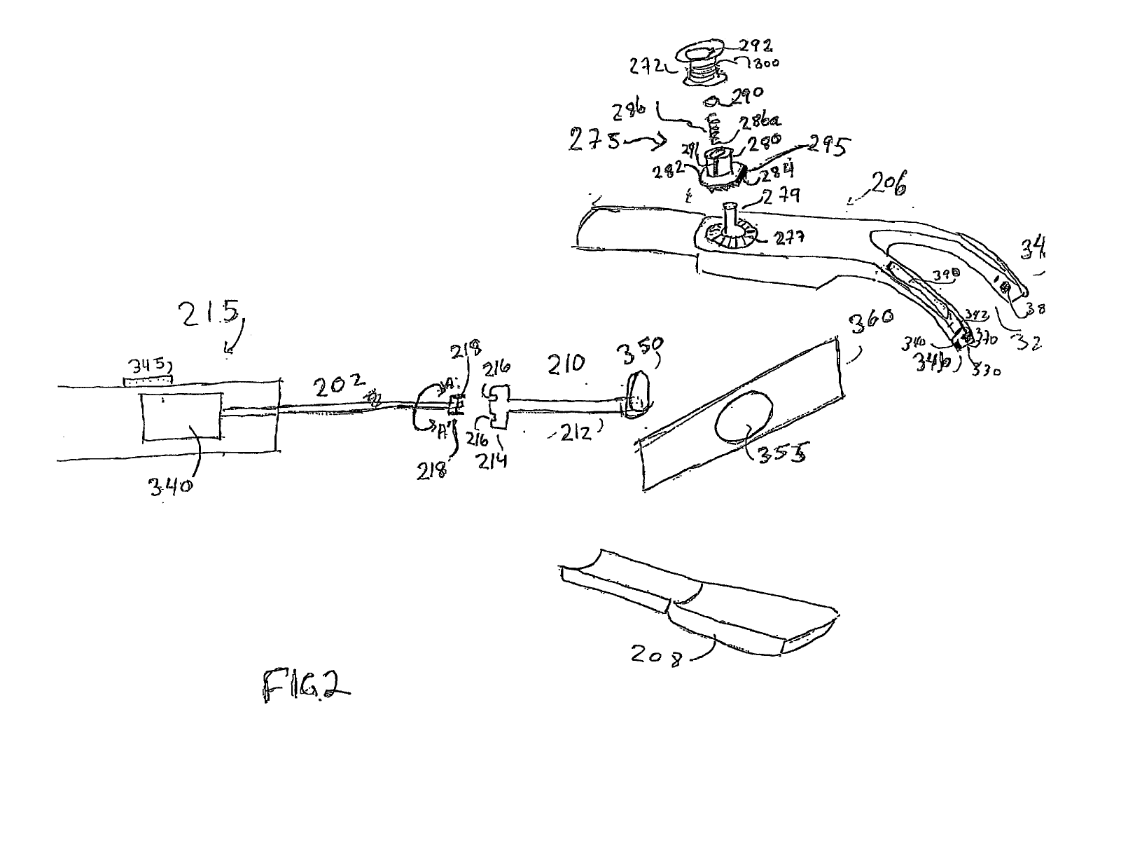

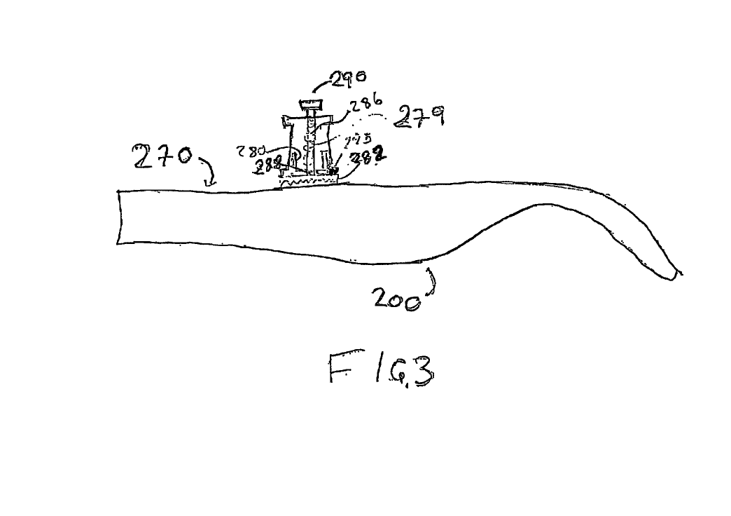

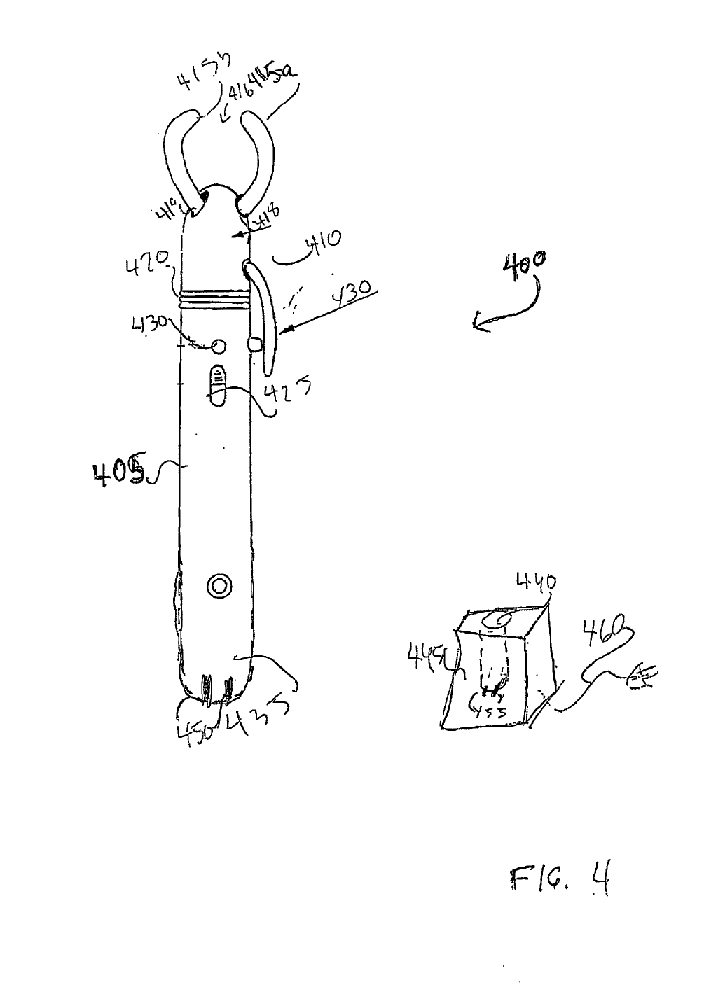

FIGS. 1 to 3 show a mechanically activated dental flossing device 200 in accordance with a first embodiment of the invention. The device consists of a flossing unit 200 attached to a handle 215. The unit 200 is comprised of a top housing 206 and a bottom housing 208 which may be screwed together. First and second tines 34a and 34b, respectively, extend from the upper housing 206 to define an inter-tine space 32. A supply of dental floss 300 is wrapped around a floss supply spool 272 mounted on a post 279 extending from an upper surface 270 of top housing 206. The floss 300 may be any commercially available, stiff floss, such as Superfloss™. From the spool 272, the floss 300 courses through a channel 310 in the top housing 206, to a hole 320 in the distal end of the first tine 34a.

The handle 215 contains a motor 340. Power to the motor may be supplied by batteries or an externally located power source. Activation of the motor by means of a switch 345 rapidly reversely rotates an output shaft 202 in opposite directions A,A′ through short arcuate intervals of approximately 60°. The handle 215 may be, for example, a commercially available electric toothbrush handle.

The unit 200 itself has no motor of its own but is activated when linked to the oscillatory output shaft 202 in the handle 215. Unit 200 includes a connector 210 having a shaft portion 212 formed with a rear socket 214 having a notched depression 216 in a rear end face thereof, corresponding in cross-section to protuberances 218 in the output shaft 202. Contact is thus maintained between the output shaft 202 and the connector 210. At a forward end of the shaft 212 a cog 350 is attached that is positioned in a hole 355 within a plate 360. The plate 360 is rigidly fixed to the inner surface of the top housing 206 and the bottom housing 208. In this manner, oscillatory motion from the output shaft 202 is transmitted to a vibrational motion of the unit 200.

The spool 272 is rotatable about the post 279 in one direction only by means of a friction mechanism generally designated with reference numeral 275. This allows floss 300 to be unwound from the spool 272 while preventing floss from being rewound onto the spool 272. A ring of ratchet-like teeth or ridges 277 extend radially in the top surface 270 of the upper housing 206 about the fixed and stationary mounting post 279. The post 279 projects upwardly through a cylindrical hub 280 which is integrally formed to project upwardly from a larger diameter disk 282 also having radial teeth 284 arranged in a circular pattern in a bottom surface thereof. The post 279 projects vertically upwardly inside the hub through a central opening 288 formed in the bottom annular wall 282. The downward facing teeth 284 are adapted to engage the upward facing stationary teeth 277 when the hub 280 is mounted to the post 279. The upper teeth 284 are spring biased against the lower teeth 277 with a spring 286 received axially within the hub 280 and about the post 279. The lower end 286a of the spring bears against a bottom annular wall 288 to press the upper teeth 284 against the lower teeth 277 under this spring bias. The length of the post 279 is slightly greater than the height of the hub 280. The post 279 thus also functions as a spring mount and a cap or washer 290 of larger diameter than the post and spring is attached to the upper end of the post to seat the upper end of the spring which is thereby compressed to a desired degree.

The hub 280 is formed with a key 291 on an outer surface thereof which is adapted to be received in a keyway 292 extending through the supply spool 272. In this manner, the supply spool 272 is co-rotationally mounted to the support hub 280 which in turn can only rotate in the unwinding direction of the floss.

In use, the device is positioned so that an interdental space between two teeth to be flossed is located in the inter-tine space 32. Vibrational motion of the unit is converted into rotational motion of the spool 272 in the unwinding direction due to an asymmetrically placed weight 295 attached to the spool 272. This rotational movement causes the floss 300 to advance from the first tine 34a through the interdental space located in the inter-tine space 32. The distal end of the dental floss is immobilized in the interior of the tine 34b by a clamp 370. The clamp 370 contains a bar 330 formed from a two-way shape memory alloy such as Nitinol® that can exist in an expanded state and in an unexpanded state. When the alloy is in its expanded state the bar 330 presses the end of the dental floss against a surface 340 so as to clamp the end of the dental floss. When the alloy is in its unexpanded state, the bar 330 does not press the end of the dental floss against the surface 340, so that the end of the dental floss is unclamped. The bar 330 passes from the unexpanded state to the expanded state by heating it by means of an electric filament 342 passing through it. The bar 330 passes from the expanded state to the unexpanded state upon cooling when no electrical current passes through the filament 342. Activation of the motor 340 also causes the tines to vibrate generating a flossing action of the interdental space.

When flossing of the interdental space is complete, a cutter 380 located in the first tine 34a is activated that cuts the floss at the first tine 34a. The cutter 380 may comprise, for example, an electrical filament that is in contact with the floss. An electrical current through the filament heats the filament and cuts the floss at the point of contact.

The device is then positioned so that a new interdental space between two teeth to be flossed is located in the inter-tine space 32. Vibration of the unit 200 causes the cut end of the floss containing the used portion to advance into a used floss receptacle 390 located in the second tine 34b. Simultaneously, new floss advances from the first tine 34a through the new interdental space and becomes locked at the second tine 34b. This process is repeated until all interdental spaces have been flossed. When the used floss receptacle is full, it may be opened and emptied of the used floss pieces.

### Second Embodiment

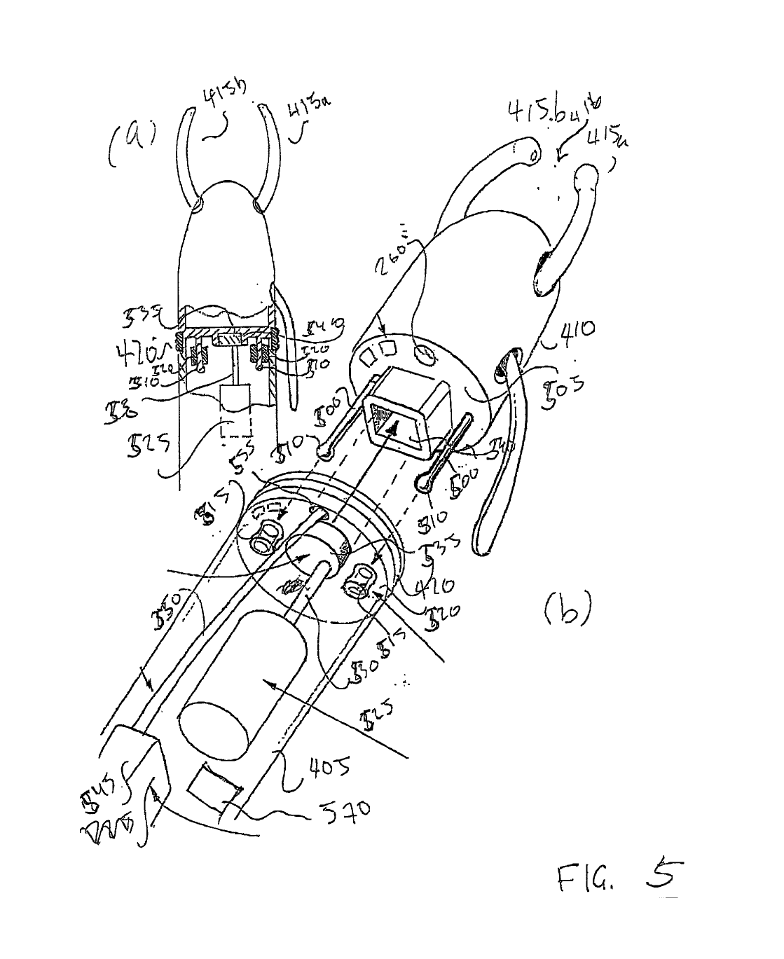

FIG. 4 shows another embodiment of the invention generally designated by 400. The flossing device in accordance with this embodiment contains a handle 405 by which the device is gripped during use, and a flossing unit 410. First and second tines 415a and 415b, respectively, extend from the flossing unit 410. A flexible ferrule 420 joining the handle 405 and the flossing unit 410 allows the flossing unit 410 to vibrate while the handle 405 is held steady. The flosser 400 is activated by closing an on-off switch 425. An indicator light 430 is illuminated when the flosser 400 is activated. The second tine 415 passes through the flossing unit 410 and exits through another side of the unit 410 to form an activating lever 430. Depression of the activating lever 430 activates a cleaning cycle of the device 400 as described in detail below. The handle 405 may contain rechargeable batteries, in which case the batteries are recharged by inserting an end 435 of the device 400 into a socket 440 of a recharger 445. When placed in the socket 440 electrical contacts 450 near the end 435 of the device 400 are in contact with electrical contacts 455 inside the socket 440. The recharger is connected to a mains power supply by an electrical cable 460.

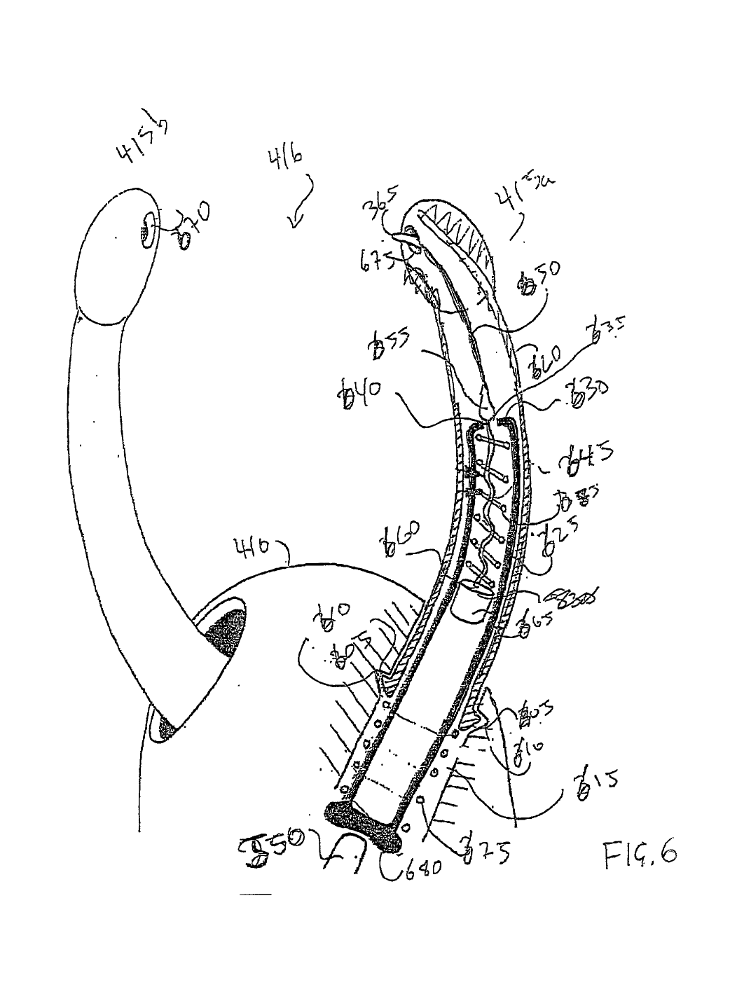

FIG. 5 shows attachment of the flossing unit 410 onto the handle 405. An assembled view is shown in FIG. 5a and an exploded view in FIG. 5b. Two pins 500 extend from a surface 505 of the flossing unit 410. The pins 500 are expanded into bulbs 510 at their tips. Each bulb 510 is received in a flexible socket 515 located below a surface 520. The sockets 515 grasp the bulbs 510 so as to provide firm attachment of the flossing unit 410 to the handle 415. The flexibility of the sockets 520 allows the flossing unit 410 to vibrate relative to the handle 405 while the flossing unit 410 is firmly attached to the handle 410.

Referring still to FIG. 5, a motor 525 is located in the handle 415 in order to generate a vibration of the flossing unit 410 relative to the handle 405. The motor 525 has a shaft 530 that passes through an opening in the surface 520 and is connected at its end to a cog 535. The cog 535 is received in a rectangular socket 540. Eccentric rotation of the cog 535 by the motor 535 generates an elliptical vibration of the flossing unit 410 including the tines 415a and 415b. A processor 570 also located in the handle 405 is configured to execute a flossing cycle, as described in detail below.

A linear actuator 545 controls longitudinal movement of a flexible shaft 550. The shaft 550 extends from the linear actuator 545 into the flossing unit 410 passing through an opening 553 in the surface 526, and through an opening 560 in the surface 505. Advance of the shaft 550 generates movement of dental floss in the intended space 416 as described in detail below.

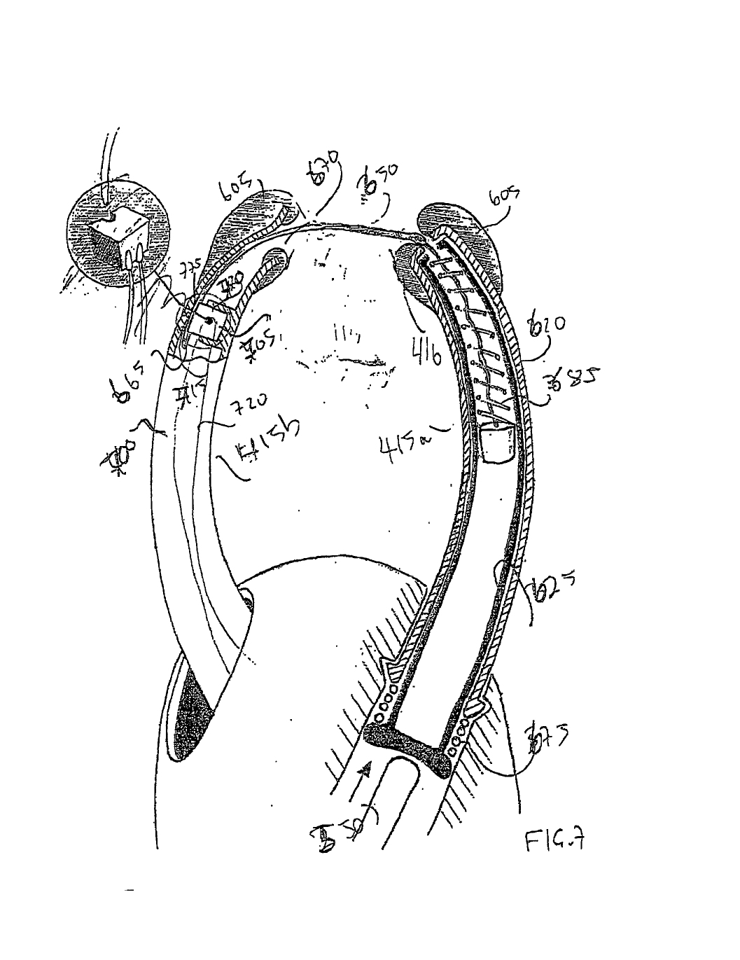

Referring now to FIG. 6, the structure of the tine 435a is shown. The tine 415a contains an outer sleeve 620 and inner sleeve 625. The inner and outer sleeves 620 and 625, respectively, are dimensioned so that the inner sleeve 625 is slidable within the outer sleeve 620. The tine 415a reversibly attaches to the flossing unit 410 by a snap attachment in which protuberances 605 on the outer sleeve 620 are received in depressions 610 in a socket 615 of the flossing unit 440. A helical spring 675 is located between the protuberances 605 of the outer sleeve and an expanded cap 680 of the inner sleeve. A distal end 630 of the inner sleeve contains an opening 633 through which a piece of dental floss 640 passes. The dental floss 640 contains a compliant portion 645 inside the inner sleeve 625 and a stiff portion 650 located outside the inner sleeve 625. The stiff portion 650 may be made from any commercially available, stiff floss, such as Superfloss™. The compliant and stiff portions 645 and 650, respectively, are joined at an expanded end 655 of the stiff portion 650. The expanded end 655 is wider than the opening 635 in the end 630 of the inner sleeve 625. The stiff portion 650 is thus prevented from entering the interior of the inner sleeve 625. A proximal end 660 of the compliant portion 645 is attached to a stopper 665 that is wider than the opening 635. A helical spring 685 is located in the inner sleeve 625. A proximal end 660 of the compliant portion 645 is attached to a stopper 665 that is wider than the opening 635. A helical spring 685 is located in the inner sleeve 625 between the end 630 of the inner sleeve 625 and the stopper 665.

As the flexible shaft 550 is advanced by the linear actuator 545, it presses upon the cap 680 of the inner sleeve 625 causing the inner sleeve 625 to slide distally in the outer sleeve 620. As the inner sleeve 625 slides in the outer sleeve 620, the spring 675 becomes compressed. Pressure of the end 630 of the inner sleeve 625 on the expanded end 653 of the stiff portion 650 of the dental floss causes the stiff portion 650 to advance distally in the outer sleeve 620, through an opening 675 in the distal end of the outer sleeve 620 into the intertine space 416, and into an opening 670 leading into the interior of the tine 445b.

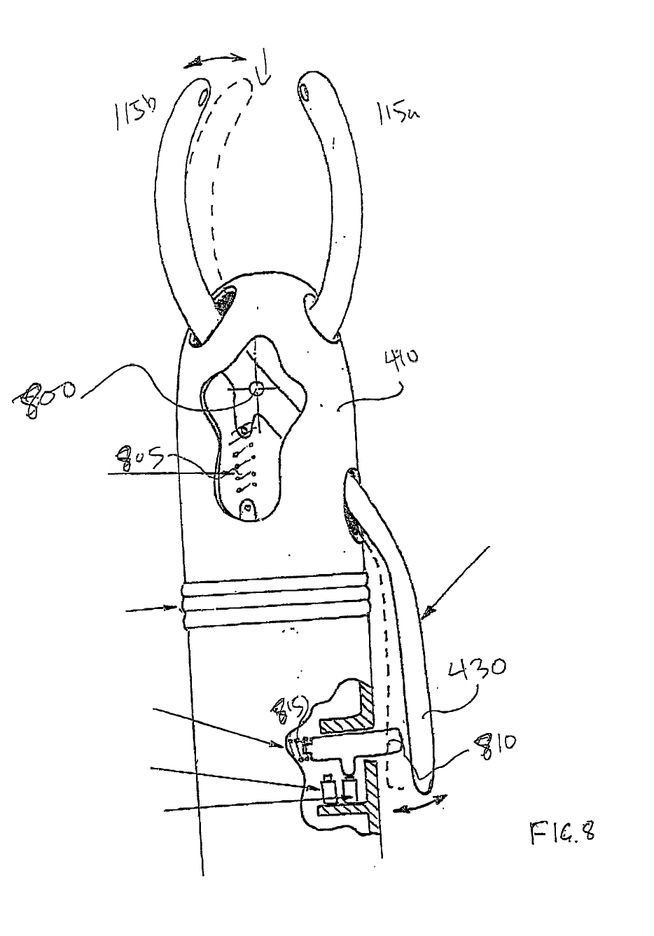

FIG. 7 shows the inner sleeve 625 after having advanced to the distal end of the outer sleeve 620. The stiff portion 650 of the dental floss completely spans the intertine space 446 and has passed through the opening 670 in the tine 451b. The distal end of the stiff portion 650 is immobilized in the interior 700 of the tine 715b by a clamp 705. The clamp 705 contains a bar 770 formed from a two-way shape memory alloy such as Nitinol® that can exist in an expanded state and in an unexpanded state. When the alloy is in its expanded state the bar 770 presses the end of the stiff portion 650 against a surface 775 so as to clamp the end of the stiff portion 650. When the alloy is in its unexpanded state, the bar 770 does not press the end of the stiff portion against the surface 775, so that the end of the stiff portion 650 is unclamped. The bar 770 passes from the unexpanded state to the expanded state by heating it by means of an electric filament 720 passing through it. The bar 770 passes from the expanded state to the unexpanded state upon cooling when no electrical current passes through the filament 720.

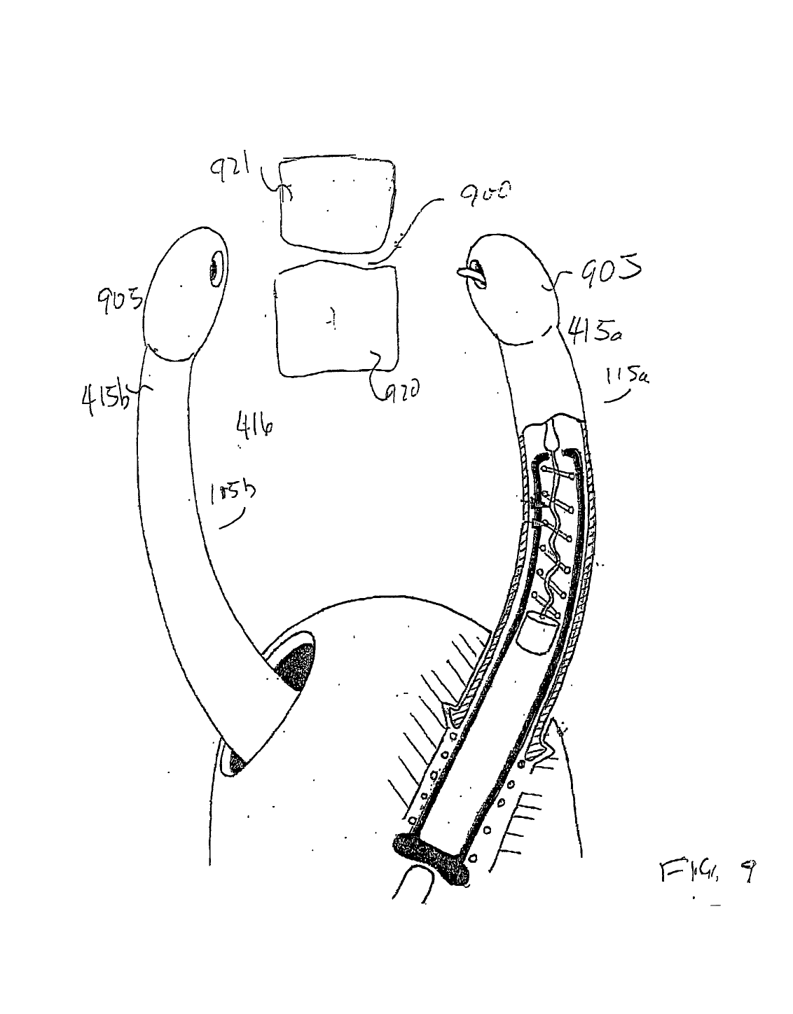

FIG. 8 shows the structure of the tine 115b. The tine 115b passes through the flossing unit 410 and at its proximal end forms the activating lever 730. The tine 115b is pivotal about the pivot 550 in the flossing unit 410. A spring 805 inside the flossing unit 410 presses upward on the tine 115b so as to establish a resting position of the tine 115b wherein the intertine space 116 is of minimal length. Depression of the activating lever 430 initially decreases the length of the intertine space 116. Further depression of the activating lever 430 closes a micro switch 810. Closing the micro switch causes the processor 570 to execute one cycle of a flossing routine as described in detail below. A spring 815 maintains the micro switch 810 in an open state when the activating lever 430 is not depressed.

Before a flossing session, the tine 115a is inserted into the socket 675. The tine 115a is preferably disposable and is used for a single flossing session before being discarded. As shown in FIG. 8a, the tines 115a and 115b are then positioned so that they straddle an interdental space 900 between two teeth 920 and 927. The activation lever 430 is then depressed so as to decrease the length of the intertine space 116 that not coincides with the interdental space 900 and to press the distal ends of the tines 115a and 115b upon the teeth 20 and 927 and on the surrounding gums. A pad 905 located at the end of each tine 115a and 115b is made from any soft material such as rubber so that contact of the tips of the tines 115a and 115b with the gums does not cause any discomfort.

The activating lever 430 is then depressed further so as to close the micro switch 570. This causes the processor to execute one cycle of the flossing routine. After the flossing routine has commenced, the activating lever 730 is released.

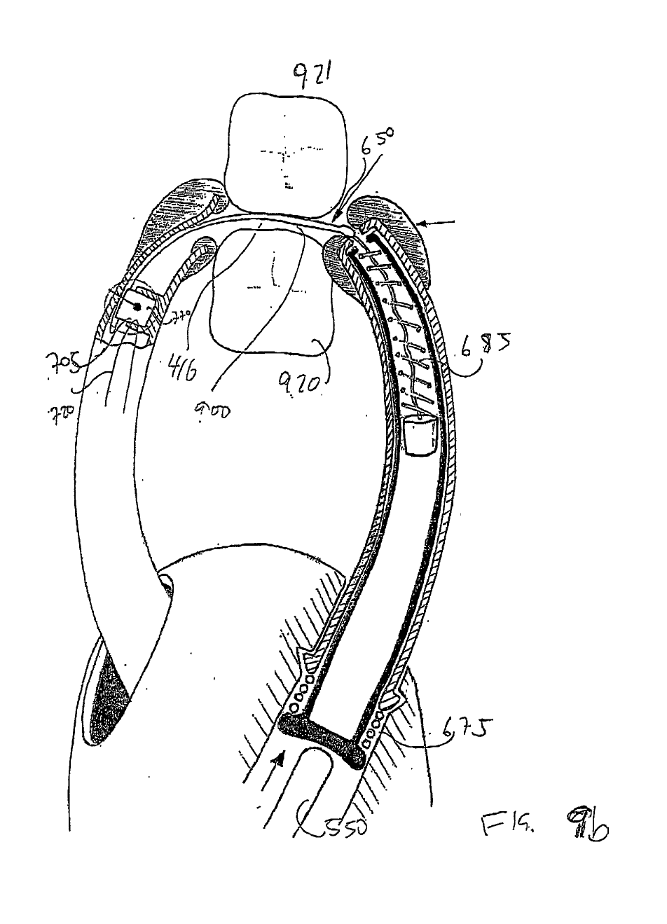

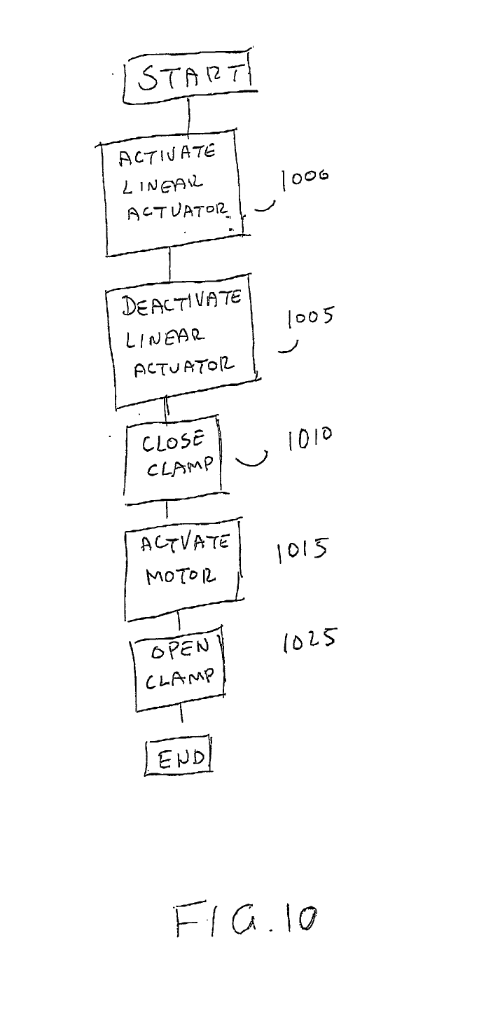

FIG. 10 shows a flow chart diagram of the flossing routine executed by the processor. In step 1000 the linear activator 575 is activated. This causes the inner sleeve 625 to advance distally in the outer sleeve 620. As the inner sleeve 625 advances in the outer sleeve 620, the spring 675 becomes compressed as shown in FIG. 9b. As explained above, advance of the inner sleeve 625 in the outer sleeve causes the stiff portion 650 of the dental floss to advance through the intertine space 116, and hence through the interdental space 900. After having passed through the interdental space, the end 665 of the stiff portion 650 enters the opening 670 in the tine 115b and enters the interior 700 of the tine 115b as shown in FIG. 9b. When the tip 665 has passed through the clamp 705 the linear activator is deactivated (step 1005).

In step 1070 the clamp 705 is closed. This is accomplished by generating an electric current through the filament 720 so as to bring the alloy of the bar 770 into its expanded state. Once the end of the stiff portion 650 has been clamped, the flexible shaft 550 is made to retreat by the linear actuator 575. This causes the inner sleeve 625 to slide proximally in the outer sleeve 620 under the influence of the spring 675. The spring 685 maintains the stiff portion 650 of the dental floss taught in the interdental space 900.

In step 1075, the motor 525 is activated. As explained above, this causes the flossing unit 770 to vibrate. Vibration of the flossing unit 770 generates an elliptical vibration of the stiff portion 650 of the dental floss in the interdental space 900. The motor is activated for a predetermined amount of time, and then deactivated (step 1020).

In step 1025, the clamp is opened by stopping the current through the filament 776 so as to allow the block 770 to cool. As the block 770 cools, the alloy forming the block 770 passes from its expanded state to its unexpanded state so as to release the end of the stiff portion 650 from the clamp 705.

When the clamp 705 has been opened, the compressed spring 675 causes the inner sleeve 625 to retreat in the outer sleeve 670. The compressed spring 675 causes the stiff portion 650 of the dental floss to retract through the opening 670 in the tine 415b, through the interdental space 900 and into the outer sleeve. The flossing cycle has thus been completed.

The flossing cycle is repeated for each interdental space. At the end of the flossing session, the disposable tine 415a is removed from the flossing unit and discarded.

1. A flossing device comprising:
(a) a first tine and second tine, each tine having a distal end, the distal ends being separated by an inter-tine space; and
(b) an advancing mechanism capable of advancing an end of a piece of floss from the distal end of the first tine to the distal end of the second tine so that at least a segment of the floss spans the inter-tine space.

2. The device according to claim 1 further comprising a clamp clamping an end of the floss to the second tine.

3. The device according to claim 1 further comprising an activating mechanism capable of generating a vibration of a segment of floss spanning the intertine space.

4. The device according to claim 1 further comprising a retrieving mechanism capable of drawing a segment of floss spanning the intertine space from the intertine space.

5. The device according to claim 1 further comprising a processor configured to execute a flossing routine comprising steps of:
(a) activating the advancing mechanism so as to advance an end of a piece of floss from the distal end of the first tine to the distal end of the second tine so that at least a segment of the floss spans the inter-tine space;
(b) activating a clamp so as to clamp the end of the floss to the second tine;
(c) activate an activating mechanism capable of generating a vibration of the segment of floss spanning the intertine space for a predetermined amount of time; and
(d) activate a retrieving mechanism capable of drawing the segment of floss spanning the intertine space from the intertine space.

6. The flossing device according to claim 1, further comprising at least one of the following:
(a) a supply of floss;
(b) a floss cutter located at the distal end of the first tine;
(c) a floss receptacle for receiving pieces of used floss.

7. The device according to claim 1 wherein the first tine is detachable from the device.

8. A method of flossing an inter-dental space between two teeth comprising the steps of:
(a) placing the inter-dental space in an intertine space of a flossing device having a first tine and a second tine;
(b) advancing a segment of floss from the first tine through the inter-dental space to the second tine;
(c) locking an end of the floss to the second tine; and
(d) vibrating the segment of floss so as to floss the inter-dental space.

9. The method of claim 8, further comprising the steps of:
(a) cutting the segment of floss with a floss cutter associated with the first tine; and
(b) advancing the segment of floss into a floss receptacle.

10. The method according to claim 8 further comprising steps of attaching the first tine to the device.

11. The method according to claim 8 further comprising a step of detaching the first tine from the device.
